(19) United States
(12) Patent Application Publication
(10) Pub. No.: US 2017/0236389 A1
(43) Pub. Date: Aug. 17, 2017

(54) Door with warning light

(71) Applicant: Rujing Tang, Plano, TX (US)

(72) Inventor: Rujing Tang, Plano, TX (US)

(73) Assignee: Rujing Tang, Plano, TX (US)

(21) Appl. No.: 15/417,061

(22) Filed: Jan. 26, 2017

Related U.S. Application Data
(60) Provisional application No. 62/295,395, filed on Feb. 15, 2016.

(51) Int. Cl. G08B 7/06; F21S 9/02; F21V 33/00; F21V 23/04; E05B 1/00; E06B 7/28

(52) U.S. Cl. CPC G08B 7/06; E05B 1/0007; E06B 7/28; F21V 33/006; F21V 23/0485; F21V 23/0407; F21S 9/02; F21Y 2115/10

(57) ABSTRACT

The present invention detects the movements or the open/close status of a door. After detection it flashes warning lights for approaching people or vehicles. In the primary embodiment, the lighting elements are displaced at the edge of the door panel to clearly indicate the edges. In another embodiment, the lighting element is displaced in a door knob that can warn the people of the opening of the door.

### BACKGROUND OF THE INVENTION

Field of the Invention

This invention is related to putting warning lights on moving edges such as the edges of doors and windows. One embodiment has warning light on the door knobs. In some embodiments the door knob could also play sound when it is about to open.

Description of Related Art

There are some door panels with lighting elements on them, but they tend to be visible to only one direction where the door panel and the lighting elements are facing. Further the lighting elements are purposed for the person using the door, not serving as a warning signal to other approaching vehicle or people.

Moving objects may present a hazard to humans and vehicles. It may not be enough for people to notice only through observing the movements of such objects. When the ambient light is not sufficient, such moving objects are even harder to be heeded and avoided. For instance, when a person exits from a vehicle that is parked along a street, the opening door could be a danger to cyclists, pedestrian, and other approaching vehicles. It is even more dangerous in dim lights.

If a door is suddenly opened, it may cause injury to a person on the other side of the door not heeding the opening of the door.

When a door in a building is opened by someone, there is little sign that the door is to be opened to the people on the other side of the door. As a result, sometimes the moving door panel could pose a hazard to passersby especially senior citizens and children. It is especially true for non-transparent door panels.

### BRIEF SUMMARY OF THE INVENTION

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

Moving objects pose safety hazards to other. The primary embodiment of the present invention installs lighting on moving edges of objects, so that the movements of the objects could be observed from distance in many different directions. The light could be flashing or in color to make it more distinct. One embodiment has the lights installed on the edge of a vehicle door.

In existing vehicle doors, the edge is typically very thin strip of metal. One embodiment is to fit lighting elements onto this thin and narrow strip of metal. The lighting itself could be a number of LED lights, encased within clear materials such as clear plastic strips. The strip of lights are snapped onto the edge of a vehicle door and further bonded with adhesives between the door edge and the plastic strip. The lights are connected to a power source, which could be from the vehicle's battery, or from a separate battery.

A contact switch controls the lights. When the vehicle is closed, the circuit disconnects. When the door is open, the circuit completes and the light starts flashing to warn the traffic from front, back or side directions. There are other types of sensors to detect the opening or closing of a vehicle door panel, such as optical sensors.

In some embodiments, the sensor that detects the opening of closing of the door could be using an accelerometer. The accelerometer is activated when it detects the movements of the door panel and then it triggers the circuit for lighting. Sometimes the accelerometer could be used in combination with other types of sensors for detecting the door position.

Further, depending on the speed detected by the accelerometer, the control circuit could effectuate different flashing pattern of the lighting elements. For Instance, faster moving door panel corresponds red light or faster flashing pattern, while slower moving corresponds yellow or slower flashing pattern. It also reminds the person who opens the door of the appropriate force to be exerted on the door panel.

There are other types of sensors that can do an adequate job of detecting whether a door is opened or closed. For instance, a light emitting device installed on the door frame send a ray of light to a light detector installed on the door panel. The light is not detected when the door panel is opened, and the sensor sends a signal to the lighting elements.

In addition, if the casing is made by flexible and shock absorption material, this embodiment could be used as a door bumper. It could avoid damage to other objects when the door is opened because of the shock absorption provided by the flexible casing.

In yet another embodiment, the vehicle door's thin metal edge could be replaced by casing that houses lighting elements. This embodiment is more suitable for factory manufacturing process. In this embodiment, the edge of the door panel could be fastened to the rest of the door panel to make the entire door panel's dimensions the same as other conventional metal door panels. Again, the casing could be made shock absorbing by using plastics or other materials, thereby make the door edge a door bumper.

In this embodiment, the power source of the lighting elements could use the existing power source of the vehicle. In addition to the contact switch mechanism mentioned earlier, the control of the lighting elements could be achieved by the movement of door opening handle or hook. Once the opening door hook is touched or pulled, the lighting elements are turned on to flash, which gives ample warning to the approaching vehicle and pedestrians.

In yet another embodiment, the lighting could be installed on doors in buildings, or other structures. When the door is opened, the lighting on the edge would flash which warns other people around it.

Yet another embodiment has the lighting installed on the door handle or knob. Typically doors have handles or knobs on both sides of the door panel. When a door handle or knob is grabbed by a person who is about to open or close the door, the lighting on the other side of the door panel will start flashing which warns the people on the other side of the imminent movement of the door panel.

The circuit and power source could be housed within the door knob or door handle.

A mere contact of the door handle or knob could trigger the light flashing by using touch sensor similar to what's in a touch activated lamp. In some embodiments, the twisting of one side of the door knob would turn on the flashing lights on the other side of the door panel. In some embodiments, a sound could play to warn as well.

Typically the lighting elements on the door knob continue to be lit after a pre-determined delay before they are turned off.

Similarly the warning system could be extended to other applications. For instance, the sensor in the warning system could be a pressure sensor to detect whether or not an object is displaced on top of the warning system. When being placed on store shelves beneath an item, the sensor can tell if the item is still on or removed from the shelf. The lighting element will be on to visually indicate to store staff if re-stocking is needed. It can be very cost effective and straightforward. The warning system is also useful for seating, parking spaces, trashcans and places where a quick visual sign helps to identify the state of the places.

There are numerous other usage scenarios for a variety of embodiments of the present invention.

### BRIEF DESCRIPTION OF THE FIGURES

FIG. 1A depicts one embodiment that the lighting elements are encased in a strip shaped housing.

FIG. 1B depicts the lighting elements and casing being bonded or fastened to the edge of a vehicle door.

FIG. 1C depicts the front view of the lighting elements being installed on the vehicle door.

FIG. 1D depicts an embodiment which comprises a vehicle door with its edge being lined with lighting elements.

FIG. 1E depicts the explosive view of the vehicle door as shown in FIG. 1D.

FIG. 2 depicts a door knob assembly with a warning light which could inform people on the other side of the door that the door knob is touched or twisted.

FIG. 3 depicts the control circuit that could make the lighting elements flash when the switch is turned on.

FIG. 4A depicts a control circuit that could trigger the lighting element by touching one door knob.

FIG. 4B depicts another control circuit that could trigger the lighting element and sound alarm by touching one door knob.

### DETAILED DESCRIPTION OF THE INVENTION

Definitions:

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

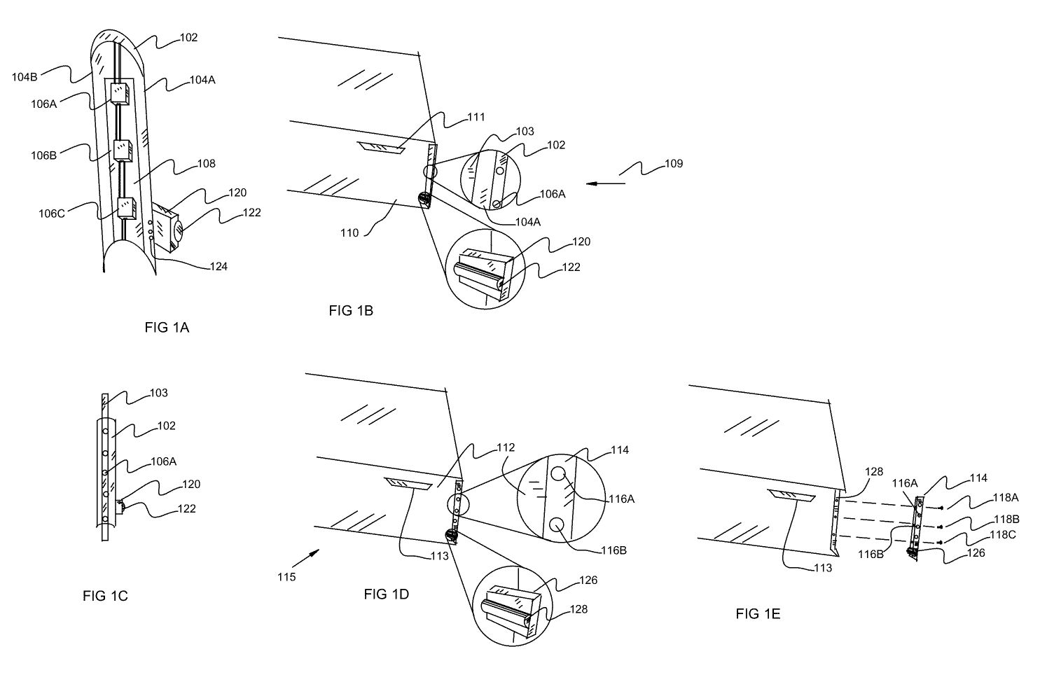

FIG. 1A depicts the lighting elements encased in a strip shaped housing. 102 is a casing to house the lighting elements comprising 106A, 106B and 106C. The lighting elements are also connected via wires and a circuit board 108. 104A and 104B are the two edges of the casing 102, which are going to cling to the door edge. Adhesive may be applied to the inside of the casing 102 including edges 104A and 104B bending toward each other for strong bonding to the door edge. The cross section shape of casing 102 is like letter ‘U’. The casing 102 is often made with flexible materials such as plastic. The shape of the casing and the edges 104A and 104B could be made in such a way that both edges 104A and 104B are touching each other before being bonded to the edge of a vehicle door.

A contact switch 120 is fastened to the edge of the casing 102 via fastener 124. The button 122 is made with flexible material which could be depressed and turn on or off the circuit to light the lighting elements 106A through 106C. When installed on door edge, the button 122 would be depressed against door frame and turn on or off the switch 120.

This embodiment is useful for after market car doors that do not have warning light installed.

FIG. 1B depicts the lighting elements and casing being fastened or bonded to the edge of a vehicle door. The vehicle door 110 has a door handle 111. The lighting element 104A and its casing 102 are being bonded to the door edge 103. The bonding could be done by applying adhesives to the inside of the casing 102 and to the door edge 103.

120 is the contact switch that can turn on or off the lighting circuit. The button 122 may be made with rubber or flexible plastic. When the door panel 110 is closed, 112 is depressed against the frame which turn on or off the lighting circuit.

109 is the direction of viewing that is detailed in FIG. 1C.

FIG. 1C depicts the front view of the lighting elements being installed on the vehicle door, which is depicted in FIG. 1B.

From the direction 109 indicated in FIG. 1B, the vehicle edge 103 is bonded to the casing 102, which is mostly transparent for the light to go through, and the lighting elements 106A is visible through the casing 102.

If the casing 102 is also flexible with at least 1/32 inch (or 0.08 centimeters) thickness, then the casing 102 could also be used as door bumper that can absorb some of the shock from bumping into another adjacent object while the vehicle door is opened.

The contact switch 120 and its button 122 control the circuit and detect whether the door is shut or open.

FIG. 1D depicts an embodiment of a vehicle door with its edge being lined with lighting elements. 115 depicts an embodiment of the present invention. The vehicle door panel 112 has an edge 114 that is installed with lighting elements 116A and 116B. The touching or opening of the door handle 113 may trigger the lighting of the lighting elements 116.

Regardless of the door handle triggering mechanism, a contact switch 126 could also trigger the lighting of lighting elements 116. If the button 128 is depressed against door frame then the switch 126 is turned on or off which in turn triggers the lighting elements of 116

FIG. 1E depicts the explosive view of the vehicle door as shown in FIG. 1D. Door handle 113 and/or the contact switch 126 could control the door lighting elements 116A and 116B. The edge 114 could be a plastic casing that houses the lighting elements 116A and 116B. The edge 114 are fastened to the door panel 112's metal parts 128 via fastener 118A, 118B and 118C.

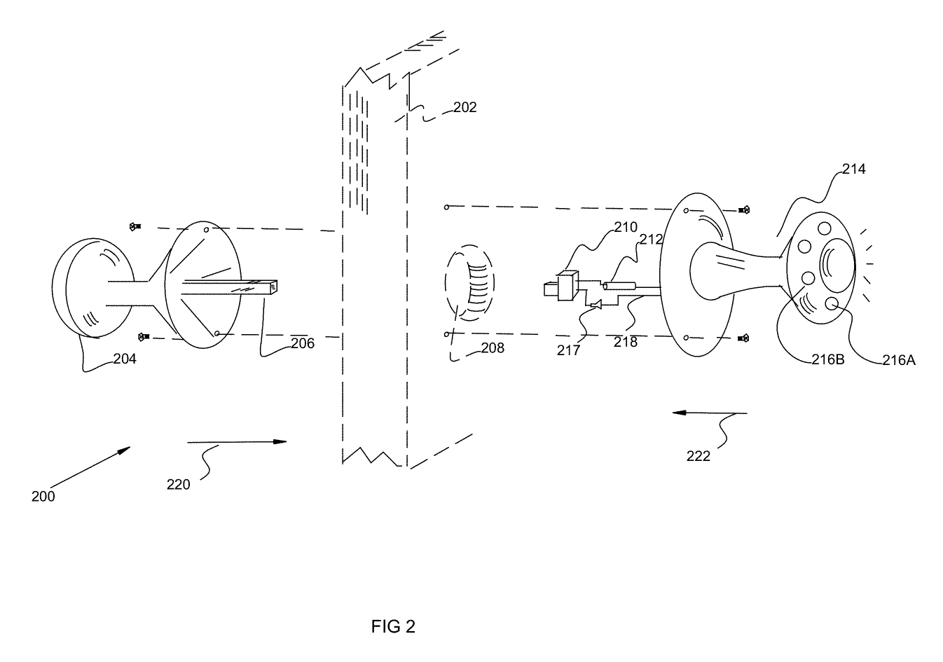

FIG. 2 depicts a door knob assembly with a warning light which could inform the people on the other side of the door that the door knob is touched or twisted.

The door knob assembly explosive view is shown in 200. Door panel 202 has a face bore 206 for the assembly to connect. The knob 204 is fastened to the door panel 202 in the direction of 220. In the middle of door knob 204 is a spindle 206, which normally controls the latch assembly (not shown here). The spindle 206 comes into contact with a contact switch 210. The twisting of door knob 204 causes the twisting of the spindle 206, which in turn controls the on or off of the contact switch 210. The contact switch is connected to a battery 212 and the lighting elements 216A and 216B. The lighting elements 216A and 216B are embedded inside the knob 214, which is fastened to the other parts in the direction indicated by 222.

The wire 218 connects to a speaker or buzzer 217, the contact switch 210, the battery 212, a control circuit and the lighting elements 216A and 216B. the speaker may play a distinct sound or music ring to give warning of the door opening.

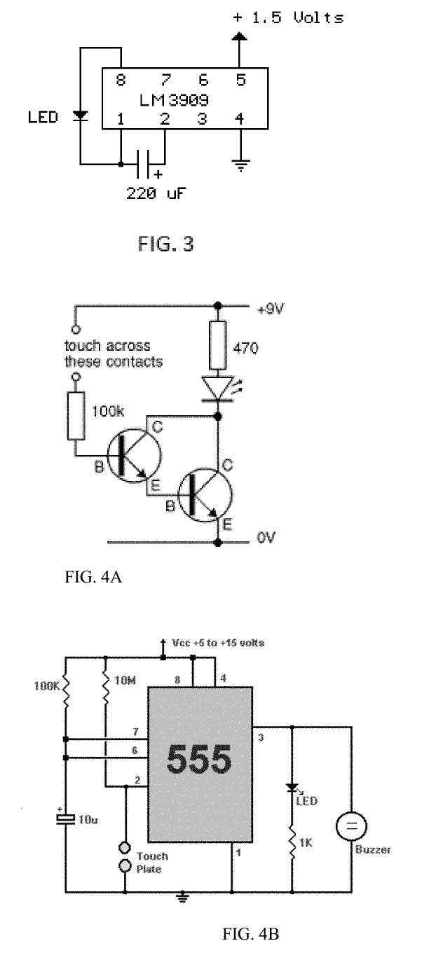

FIG. 3 depicts the control circuit that could make the lighting elements flash when the switch is turned on. IC LM3909 controls the flashing of the LED light. FIG. 4A depicts a control circuit that could trigger the lighting element by touching one door knob.

The ‘touch across these contacts’ is where the door knob being touched or twisted. The LED light is installed on the other side of the door knob.

FIG. 4B depicts another control circuit that could trigger the lighting element and sound alarm by touching one door knob. The ‘touch plate’ is where the door knob is being touched or twisted. The LED light and the buzzer are installed on the other side of the door knob. IC 555 is for sensing and controlling the circuit.

These circuits could be applied to control all the lighting elements mentioned in the various embodiments.

It should be appreciated that all the circuits shown here could be replaced by many other circuits designs that carry out similar functions.

In all the figures mentioned above, the lighting elements could be LED lights. LED lights typically enjoy small form factor and low power consumption. In addition these lighting elements could be enhanced by adding reflective surfaces such as mirrors around them.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art will be able to design and incorporate any one of the variety of mechanisms suitable for accomplishing the above described functionalities.

It is to be understood that the disclosure teaches just one example of the illustrative embodiment and that many variations of the invention can easily be devised by those skilled in the art after reading this disclosure and that the scope of then present invention is to be determined by the following claims.

What is claimed is:

1. A door with edge warning lighting comprising:
a door panel;
a plurality of lighting elements being displaced along the edge of the door panel; and
a sensor being connected to the lighting elements for detecting the position of the door panel and controlling the lighting elements.

2. The door according to claim 1, wherein the lighting elements are LED lights.

3. The door according to claim 1, wherein the lighting elements flash when the sensor detects the door panel position change.

4. The door according to claim 1, further comprising a casing wherein the lighting elements are housed inside the casing.

5. The door according to claim 1, wherein the sensor comprises a contact switch.

6. The door according to claim 1, wherein the sensor comprises an accelerometer or a light detector.

7. The door according to claim 1, wherein the lighting elements' flashing patterns and colors are controlled by the sensor.

8. The casing according to claim 4, is made from shock absorption material as a door bumper.

9. A warning lighting strip comprising:
a plurality of lighting elements;
a casing for housing the plurality of lighting elements; and
a sensor being connected to the plurality of lighting elements.
wherein the sensor is configured to detect the movement of the casing or the position of the casing.

10. The warning lighting strip according to claim 9, furthering comprising: an adhesive material being applied inside the casing for attaching the warning lighting strip to a edge of a vehicle door,

11. The warning lighting strip according to claim 9, wherein the sensor is a contact switch.

12. The warning lighting strip according to claim 9, wherein the sensor is an accelerometer.

13. The warning lighting strip according to claim 9, wherein the lighting elements flash when the sensor detects movement of the casing.

14. A door knob assembly for alerting door movement, comprising:
a first knob;
a second knob being connected to the first knob;
a sensor being displaced inside the door knob assembly;
a plurality of lighting elements being fastened to the first knob; and
a power source being connected to the lighting elements;
Wherein the sensor controls the lighting elements.

15. The door knob assembly according to claim 14, wherein the lighting elements are lit when the sensor detects the second door knob being touched.

16. The door knob assembly according to claim 14, wherein the sensor is a contact switch that closes the lighting circuit when the second door knob is being twisted.

17. The door knob assembly according to claim 14, wherein the sensor comprises a touch sensor that detects the hand touching the second knob.

18. The door knob assembly according to claim 14, further comprising a sound device, wherein the sound device plays a warning sound when the second knob is touched or twisted.

19. The door knob assembly according to claim 14, wherein the power source is a battery.

20. The door knob assembly according to claim 14, wherein the lighting element is displaced on the surface of the first knob in such a way that the light is visible from all directions in front of the first knob.
